(19) United States
(12) Patent Application Publication
(10) Pub. No.: US 2024/0402681 A1
(43) Pub. Date: Dec. 5, 2024

(54) SYSTEM AND METHOD OF CONTROLLING A PLURALITY OF VARIABLE SPEED PUMPS

(71) Applicant: CARMEL HAIFA UNIVERSITY ECONOMIC CORPORATION LTD., Haifa (IL)

(72) Inventors: Mashor HOUSH, Kfar Manda (IL); Elad SALOMONS, Haifa (IL)

(21) Appl. No.: 18/802,066

(22) Filed: Aug. 13, 2024

Related U.S. Application Data
(63) Continuation of application No. PCT/IL2023/050148, filed on Feb. 13, 2023.
(60) Provisional application No. 63/309,577, filed on Feb. 13, 2022.

(51) Int. Cl. G05B 19/416

(52) U.S. Cl. CPC G05B 19/416; G05B 2219/45219

(57) ABSTRACT

The present invention relates generally to the field of automated process control systems and methods. More specifically, the present invention relates to controlling a pumping station including a plurality of variable speed pumps connected to a closed supply network (e.g., a water distribution system (WDS)). The claimed invention represents a system and method of controlling a plurality of VSPs, which provide a technical improvement of a technical field of automated process control by decreasing the total and instantaneous power consumption of the plurality of VSPs while maintaining the required flow volume demand at the desired pressure setpoint, as well as increasing the effectiveness of adjustment to changing demands of the network and extending motor life of pumps by balancing frequency of their starts and stops.

### CROSS-REFERENCE TO RELATED APPLICATIONS

This application is a Bypass Continuation of PCT Patent Application No. PCT/IL2023/050148 having International filing date of Feb. 13, 2023, which claims the benefit of priority of U.S. Patent Application No. 63/309,577, filed Feb. 13, 2022, and entitled: “LOCAL CONTROL SCHEMES FOR REAL-TIME OPTIMIZATION OF VARIABLE SPEED PUMPS”. The contents of which are all incorporated herein by reference in their entirety.

### FIELD OF THE INVENTION

The present invention relates generally to the field of automated process control systems and methods. More specifically, the present invention relates to controlling a pumping station including a plurality of variable speed pumps connected to a closed supply network (e.g., a water distribution system (WDS)).

### BACKGROUND OF THE INVENTION

Variable speed pumps (VSP) are used to maintain a desired flow or pressure. As known in the art, VSPs are common because they provide several advantages, including a) the pump flow can change gradually and give the upstream process (e.g., closed supply network used within a treatment plant or water distribution system) time to adjust; b) no water storage is required on the demand side, as the pump can adjust to changing demands while maintaining the required pressure in the demand zone (i.e., in the closed supply network); c) the flow can be changed gradually to reduce water hammer, and d) motor life can be extended since fewer starts and stops are needed.

With the VSPs gaining popularity in practice, they have been modeled in most simulation software known in the art (such as EPANET), and their modeling and simulation continue to be an active research topic. Many studies of VSPs address the operation of WDSs and optimization of pumps scheduling (i.e., scheduling the reconfiguration of their speed and on/off condition). Some teachings known in the prior art report improved system efficiency (e.g., water distribution system) due to VSPs and other benefits of an increased level of flexibility in controlling WDSs in real-time. Some teachings of the prior art suggest using VSPs as a tool to recover energy and reduce leakage in WDSs. Other teachings suggest incorporating VSPs in the design stage of water networks and transmission lines. It is also known from the art that the option of using VSPs in deep injection well systems was also explored.

The operation of VSPs for pressure control in a closed pipe system is a well-known problem in the art. However, a simple and practical methodology is still required for optimal operation of an entire pumping station (including a plurality of VSPs) to utilize the VSPs better and reduce energy costs. One of the most common controllers used is the proportional-integral-derivative (PID) controller. A PID controller continuously calculates the difference (error) between the desired setpoint (i.e., pressure setpoint value) and the measured variable (i.e., current pressure value). Then it applies a correction based on proportional, integral, and derivative terms of the error.

The PID algorithm is traditional in control applications, and it is implemented in many control system use cases. However, it is not uniquely tailored for pumping systems. In particular, the known methods of controlling VSPs employ control rules to keep the feedback signal (i.e., current pressure) at the desired setpoint regardless of the energy efficiency and hydraulics. Therefore, known methods are characterized by having unreasonably high power consumption, ineffective adjustment to changing demands of the network, and low motor life of pumps caused by their excessively frequent starts and stops.

### SUMMARY OF THE INVENTION

Accordingly, there is a need for a system and method of controlling a plurality of VSPs, which would provide a technical improvement of a technical field of automated process control by decreasing the total and instantaneous power consumption of the plurality of VSPs while maintaining the required flow volume demand at the desired pressure setpoint, as well as increasing the effectiveness of adjustment to changing demands of the network and extending motor life of pumps by balancing frequency of their starts and stops.

In the general aspect of the present invention, a method of controlling a plurality of variable speed pumps (VSPs) connected to a closed supply network, by at least one processor, is provided, the method including receiving (i) a pressure setpoint value, representing a pressure value to be maintained in the network; (ii) a preceding pressure value in the network; (iii) a preceding set of operating speed values of the plurality of VSPs; (iv) a Q-H characteristic for each of the plurality of the VSPs; and (v) a pump efficiency characteristic for each of the plurality of the VSPs; estimating a flow volume demand of the network, based on (i) the preceding pressure value; (ii) the preceding set of operating speed values and (iii) the Q-H characteristics of the plurality of the VSPs; calculating a new set of operating speed values of the plurality of VSPs, based on (i) the pressure setpoint value; (ii) the Q-H characteristics of the plurality of the VSPs; (iii) the pump efficiency characteristics of the plurality of the VSPs; and (iv) the estimated current flow volume demand; such as to provide the estimated current flow volume demand at the pressure setpoint value with a lowest total power consumption, determined by the pump efficiency characteristics; and reconfiguring the plurality of the VSPs by setting up the new set of operating speed values.

In another general aspect of the present invention, a system for controlling a plurality of variable speed pumps (VSPs) connected to a closed supply network, is provided, the system including a non-transitory memory device, wherein modules of instruction code are stored, and at least one processor associated with the memory device, and configured to execute the modules of instruction code, whereupon execution of said modules of instruction code, the at least one processor is configured to receive (i) a pressure setpoint value, representing a pressure value to be maintained in the network; (ii) a preceding pressure value in the network; (iii) a preceding set of operating speed values of the plurality of VSPs; (iv) a Q-H characteristic for each of the plurality of the VSPs; and (v) a pump efficiency characteristic for each of the plurality of the VSPs; estimate a current flow volume demand of the network, based on (i) the preceding pressure value; (ii) the preceding set of operating speed values and (iii) the Q-H characteristics of the plurality of the VSPs; calculate a new set of operating speed values of the plurality of VSPs, based on (i) the pressure setpoint value; (ii) the Q-H characteristics of the plurality of the VSPs; (iii) the pump efficiency characteristics of the plurality of the VSPs; and (iv) the estimated current flow volume demand; such as to provide the estimated current flow volume demand at the pressure setpoint value with a lowest total power consumption, determined by the pump efficiency characteristics; and reconfigure the plurality of the VSPs by setting up the new set of operating speed values.

In some embodiments, the method may further include receiving a power status for each of the plurality of the VSPs, indicating whether a respective VSP is active or inactive; and calculating the new set of operating speed values, further based on the power statuses of the plurality of the VSPs.

In some embodiments, the method may further include receiving a power status constraint parameter, representing an upper limit of a power status change frequency; and calculating the new set of operating speed values, further based on the power status constraint parameter.

In some embodiments, the method further may further include receiving maximum and minimum allowed operating speed values for each of the plurality of the VSPs; and calculating the new set of operating speed values, by selecting each of operating speed values within a range, defined by a respective maximum and minimum allowed operating speed values.

In some embodiments, estimating the flow volume demand may include calculating a sum of flow volumes of the plurality of the VSPs for the preceding pressure value.

In some embodiments, calculating the new set of operating speed values of the plurality of VSPs may include calculating a plurality of feasible sets of operating speed values, based on (i) the pressure setpoint value; (ii) the Q-H characteristics of the plurality of the VSPs; and (iii) the estimated current flow volume demand; each providing the estimated current flow volume demand at the pressure setpoint value; for each of the plurality of feasible sets of operating speed values, calculating a total power consumption of the plurality of the VSPs, derived from the pump efficiency characteristics of the plurality of the VSPs; selecting the new set of operating speed values from the plurality of feasible sets of operating speed values, having the lowest total power consumption of the plurality of the VSPs.

In some embodiments, calculating the plurality of the feasible sets of the operating speed values may include selecting at least one VSP from the plurality of the VSPs; and calculating each of the plurality of the feasible sets of the operating speed values by selecting the operating speed values for the rest of the plurality of the VSPs; calculating a sum of the flow volumes of the rest of the plurality of the VSPs for the pressure setpoint value, according to the selected operating speed values for the rest of the plurality of the VSPs; calculating the flow volume of the selected at least one VSP as a difference between the estimated current flow volume demand and the sum of the flow volumes of the rest of the plurality of the VSPs; calculating the operating speed value of the selected at least one VSP, based on (i) the flow volume of the selected at least one VSP; (ii) the Q-H characteristic of the selected at least one VSP; and (iii) the pressure setpoint value.

In some embodiments, calculating the total power consumption of the plurality of the VSPs may further include for each of the plurality of the VSPs, calculating a pump efficiency value, based on (i) the operating speed value of the respective VSP according to the respective feasible set; (ii) flow volume of the respective VSP for the pressure setpoint value; (iii) the pump efficiency characteristic of the respective VSP; and calculating the total power consumption of the plurality of the VSPs, based on (i) the pressure setpoint value; (ii) the flow volume of each of the plurality of the VSPs for the pressure setpoint value; (iv) the calculated pump efficiency value of each of the plurality of the VSPs.

In some embodiments, the method may further include receiving maximum and minimum allowed operating speed values for each of the plurality of the VSPs; and wherein selecting the operating speed values for the rest of the plurality of the VSPs may include, for each of the rest of the plurality of the VSPs, discretizing the operating speed values within a range, defined by a respective maximum and minimum allowed operating speed values, thereby obtaining a plurality of discrete operating speed values; and selecting the operating speed values for the rest of the plurality of the VSPs from the pluralities of the discrete operating speed values.

In some embodiments, calculating the plurality of the feasible sets of the operating speed values may further include excluding the feasible sets of the operating speed values having the operating speed value of the selected at least one VSP out of the range, defined by a respective maximum and minimum allowed operating speed values.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a plot, representing an example of a flow volume demand estimation for two active pumps, according to some embodiments;

FIG. 2 is an algorithm of calculating a plurality of feasible sets of operating speed values;

FIG. 3 is a block diagram, depicting a computing device which may be included in the system for controlling a plurality of VSP, according to some embodiments;

FIG. 4 is a block diagram, depicting a system for controlling a plurality of VSP, according to some embodiments;

FIG. 5 is a flow diagram, depicting a method of controlling a plurality of VSP, according to some embodiments;

FIG. 6 is a block diagram, depicting a VSP control loop known in the art;

FIG. 7 is a block diagram, depicting a proposed control loop according to some embodiments of the claimed method and system;

FIG. 8 is a scheme, depicting water lines (GIS layer) for pressure zone 330P;

FIG. 9 is a schematic representation of pressure zone 330P;

FIG. 10 is an orthophoto of Hazerim pumping station;

FIG. 11 is a SCADA screen of Hazerim pumping station;

FIG. 12 is plot, depicting a discharge pressure of Hazerim pumping station;

FIG. 13 is a plot, depicting individual pump curves for the test case pumping station;

FIG. 14 is a plot, depicting an Error vs. Change in the speed of Pump 1;

FIG. 15 are a set of plots, depicting measured and simulated pressures;

FIG. 16 is a plot, depicting power consumption for different operational strategies;

FIG. 17 is a plot, depicting cumulative probability density function of the absolute pressure deviation from the set pressure for the three strategies;

FIG. 18 is a set of diagrams, depicting operation hours for the three strategies;

FIG. 19 is a set of plots, depicting an optimal schedule of the pumps during the first two days of the week of the test;

FIG. 20 is a chart, depicting overall saving of the optimization approaches.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

The terms “demand zone”, “closed supply network”, “demand side”, “closed pipe system” etc. may be used herein interchangeably.

The terms “flow”, “demand”, “flow volume demand”, “flow volume” etc. may be used herein interchangeably.

The terms “pump”, “variable speed pump”, “VSP” etc. may be used herein interchangeably.

The terms “on/off condition”, “power status”, “power condition”, “on/off status” etc. may be used herein interchangeably.

The terms “energy costs”, “power consumption” etc. may be used herein interchangeably.

The terms “setpoint”, “pressure setpoint value”, “target pressure setpoint” etc. may be used herein interchangeably.

The terms “flow-head characteristic curve”, “Q-H characteristic” etc. may be used herein interchangeably.

The terms “pump efficiency characteristic curve”, “pump efficiency characteristic”, “efficiency curve” etc. may be used herein interchangeably.

The terms “operating speed”, “speed”, “pump speed” etc. may be used herein interchangeably.

It should be understood that, in the context of the application, terms used herein interchangeably may be marked and referred to by same numerical identifiers.

It should be understood that, in the context of the present application, term “current” should be interpreted as referring to timepoint t, term “preceding” or “previous” should be interpreted as referring to timepoint t−1, and term “following” should be interpreted as referring to timepoint t+1.

Although embodiments of the invention are not limited in this regard, discussions utilizing terms such as, for example, “processing,” “computing,” “calculating,” “estimating,” “determining,” “establishing”, “analyzing”, “checking”, “choosing”, “selecting”, “omitting”, “training” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, concurrently, or iteratively and repeatedly.

In some embodiments of the present invention, some steps of the claimed method may be performed by utilizing known machine learning (ML) and artificial intelligence (AI) techniques, e.g., by utilizing an artificial neural network (ANN).

A neural network (NN) or an artificial neural network (ANN), e.g., a neural network implementing an ML or AI function, may refer to an information processing paradigm that may include nodes, referred to as neurons, organized into layers, with links between the neurons. The links may transfer signals between neurons and may be associated with weights. A NN may be configured or trained for a specific task. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

It should be obvious for the one ordinarily skilled in the art that various ML-based models can be implemented without departing from the essence of the present invention. It should also be understood, that in some embodiments ML-based model may be a single ML-based model or a set (ensemble) of ML-based models realizing as a whole the same function as a single one. Hence, in view of the scope of the present invention, the abovementioned variants should be considered equivalent.

As can be seen, embodiments of the present invention may rely on a physical model of pumps' hydraulics and efficiencies. Unlike current practice, the claimed invention may utilize the pumps' characteristics curves for ensuring hydraulic feasibility while sustaining the required pressure setpoint. Embodiments of the claimed invention may represent a model-based approach tailored explicitly for pumping stations (e.g., plurality of VSPs) that work against closed areas without storage. Unlike the traditional approach, it is suggested to consider optimization of energy costs (i.e., power consumption) and longevity of pumps life as a primary objective while satisfying the setpoint constraints. In particular, it is suggested to solve an optimization problem to minimize energy consumption by evaluating the pump curves (e.g., efficiency and flow-head (Q-H) characteristic curves) to choose the lowest energy consumptions that meet the target pressure setpoint.

According to some embodiments of the claimed invention, the controlling may be performed by calculating and applying decision variables, such as the on/off status (power status) of the pumps and their operating speed. A main objective may be, according to some embodiments, to minimize instantaneous power consumption. In some embodiments, the optimization problem may incorporate bound constraints on the speeds, time gap constraints to prevent frequent pump changes, and physical constraints that quantify the operation point (the combination of pressure setpoint and flow volume demand) in the flow-head and flow-efficiency domains.

Since the for each VSP H-Q characteristic with the change of its speed and efficiency in different points of H-Q characteristic is different, the overall H-Q characteristic and the overall efficiency of the plurality of VSPs hence depend on the combination of speeds of the plurality of VSPs. Hence, to achieve a setpoint pressure, the various combinations (sets) of speeds of pumps may be selected, and the correspondent instantaneous power consumption of each pump may be different. Thus, the same operation mode of the system may be achieved with different power consumption. Consequently, the purpose is to find the combination with the lowest feasible power consumption.

It should be understood that the claimed invention is not limited by specific techniques of calculating the abovementioned decision variables. Indication of specific techniques herein should be considered as an illustrative non-exclusive example, and other known techniques may be implemented not being out of the scope of the claimed invention.

First, to formulate the constraints, the water demand (flow volume demand) should be estimated. According to some embodiments, the estimation may be performed using known operational conditions, such as: set of operating speed values of VSPs, power statuses of VSPs, preceding pressure value in the network, and the like, from a previous time step, to estimate the future water demand in the current time step. In some embodiments, the method may include the following steps:

The first stage is a demand estimation based on the current system state and all pumps' known flow-head characteristic curves (Q-H characteristics).

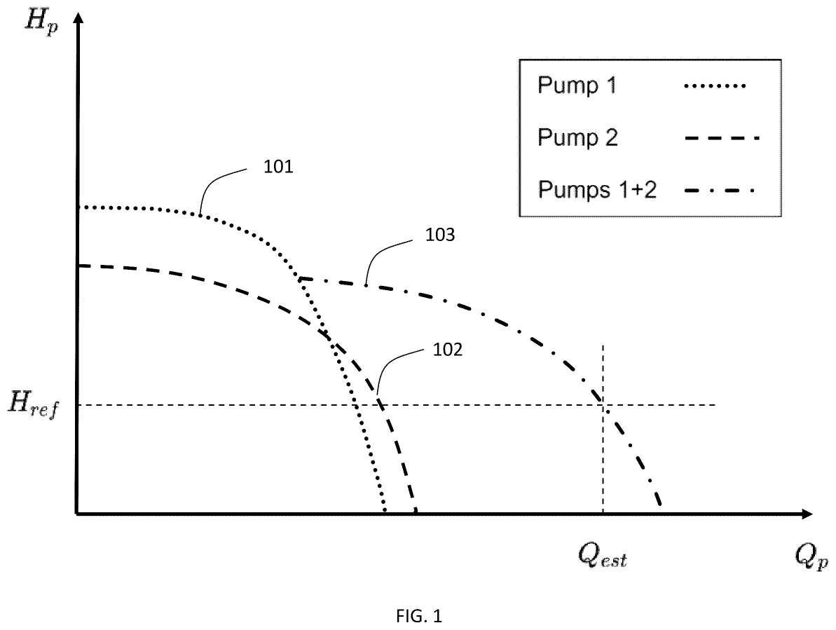

Referring to FIG. 1, it is provided a schematic demonstration of this flow volume demand estimation, which, algebraically, involves solving a nonlinear equation.

The figure shows two flow-head characteristic curves (i.e., Q-H characteristics 101 and 102) for two active pumps at time step t. These are the active pumps (i.e., ON pumps) out of a set of available pumps in the station. The curve 103 represents the combined curve (of curves 101 and 102), which is the flow-head relationship of the pumping station at time t. Using the pressure measurement at time t, it is suggested to estimate the water demand (i.e., current flow volume demand) at time t using the following equation:

$${Q}_{est , t} = {\sum }_{p ∈ P} {I}_{p , t - 1} \cdot \sqrt{\frac{{( \frac{{n}_{p , t - 1}}{{n}_{max}} )}^{2} \cdot {a}_{p} - {H}_{t - 1}}{{b}_{p}}} ,$$

where aₚ and bₚ are the coefficients of the Q-H pump characteristic curve of pump p of the plurality P of VSPs, I is a power status (e.g., On/Off) of respective VSP, nₚ is a preceding speed value of the respective VSP, Hₜ₋₁ is a preceding pressure value in the network.

The next stage is determining the set of feasible speeds for given pumps combinations. Given the estimated flow (Qₑₛₜ, e.g., the estimated current flow volume demand) and a potential pump combination, it is suggested to seek the set of feasible speeds that reach the operation point of the required pressure setpoint and the estimated flow. While this problem is highly nonlinear, it is suggested to rely on a direct search of feasible speeds since the problem dimension is small. That is, it is suggested, according to some embodiments, to discretize the allowed speed range and check for the feasibility of each option (e.g., of each set of operating speed values). Nonetheless, to reach the operation point accurately, it is suggested to use, for the calculations, at least one of the pumps with continuous speed values while the other pumps may have or may be limited to discretized speeds.

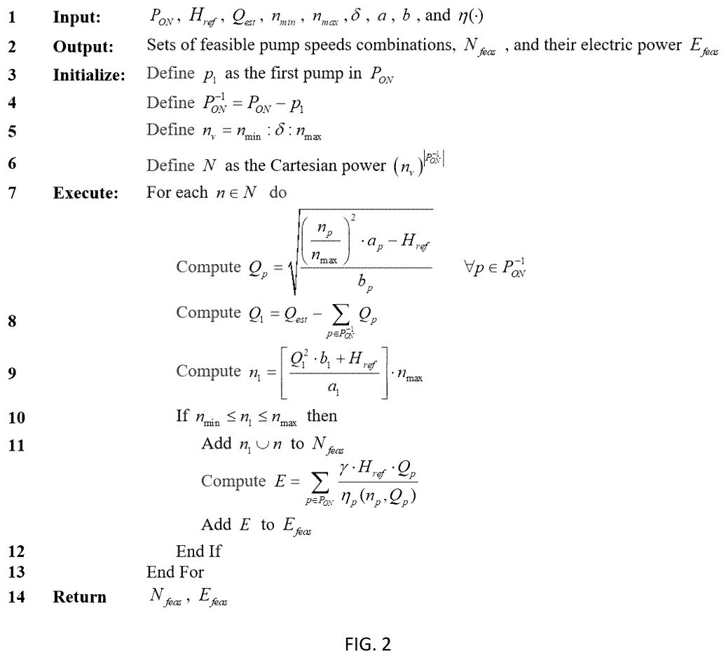

An algorithm shown in FIG. 2 describes an example of a search of feasible sets of operating speed values of the plurality of VSPs.

As shown in line 1 of the algorithm, it uses as an input set of active VSPs P_{ON}, pressure setpoint value H_{ref}, the estimated current flow volume demand Qₑₛₜ, minimum and maximum allowable speed values nₘᵢₙ and nₘₐₓ, discretization step δ, coefficients of the Q-H pump characteristic curve a, b, and efficiency characteristic function η(·).

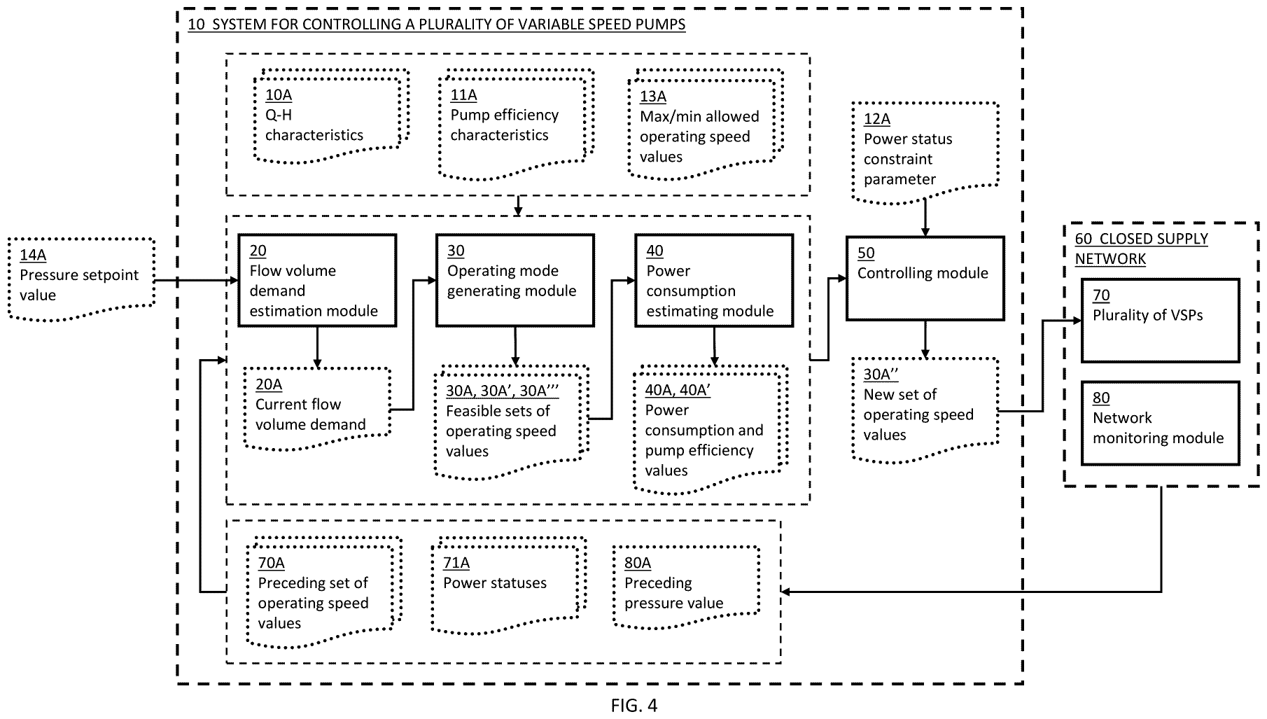

While the steps of the algorithm as provided in FIG. 2 are self explanatory, they are described in detail with reference to FIG. 4.

The next stage of methods according to embodiments of the present invention is a direct search for the optimal active pumps' combination. In this module, it is suggested to enumerate all pump combinations in the pumping station. For example, in a pump station with four pumps, there are 2⁴−1=15 possible combinations of active pumps, C. For each combination the abovementioned algorithm (shown in FIG. 2 and described with reference to FIG. 4) is called, and its output is saved. Two families (i.e., set of sets) are obtained after looping over all the combinations. The first is N_{f eas}^{c}∀c∈C which holds all the feasible speeds for each combination (i.e., feasible sets of operating speed values), and the second is E_{f eas}^{c}∀c∈C, which holds the electric energy (i.e., power consumption). Constraints can be imposed on some of the combinations. For example, some combinations may be ruled out to prevent frequent changes in active pumps. That is, if pump 1 started at time t, only those combinations should be considered that have active pump 1 for a predetermined time window t: t+w. Similarly, in some embodiments, it is suggested to filter out combinations with unavailable pumps at any period (e.g., malfunctioning pumps). After ruling out unwanted combinations, it is suggested to output the option (i.e., new set of operating speed values) with the lowest electric power from c*∈C, n*∈N_{f eas}^{c} and E*∈E_{f eas}^{c}.

The stages described above can be easily modified to account for additional operational constraints. E.g., the method may implement the following two operation strategies: the first is the “free strategy” in which each pump can operate with a different speed inside a predetermined speed range (according to the abovementioned algorithm). The second is the “equal strategy” in which all active pumps share the same speed. For example, to implement the equal strategy, module 2 can be modified in Line 6 to loop over elements of N that has the same speeds, and the feasibility condition in Line 10 should be modified to nₚ−δ≤n₁≤nₚ+δ.

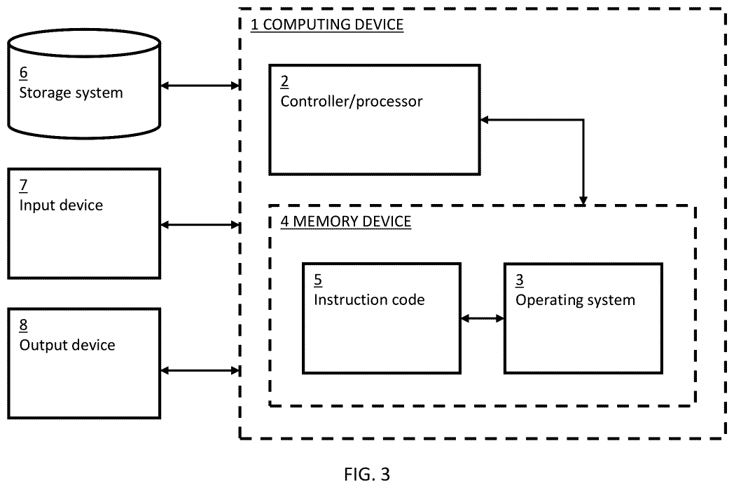

Reference is now made to FIG. 3, which is a block diagram depicting a computing device, which may be included within an embodiment of the system for controlling a plurality of VSPs, according to some embodiments.

Computing device 1 may include a processor or controller 2 that may be, for example, a central processing unit (CPU) processor, a chip or any suitable computing or computational device, an operating system 3, a memory device 4, instruction code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to instruction code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory device 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory device 4 may be or may include a plurality of possibly different memory units. Memory device 4 may be a computer or processor non-transitory readable medium, or a computer non-transitory storage medium, e.g., a RAM. In one embodiment, a non-transitory storage medium such as memory device 4, a hard disk drive, another storage device, etc. may store instructions or code which when executed by a processor may cause the processor to carry out methods as described herein.

Instruction code 5 may be any executable code, e.g., an application, a program, a process, task, or script. Instruction code 5 may be executed by processor or controller 2 possibly under control of operating system 3. For example, instruction code 5 may be a standalone application or an API module that may be configured to perform controlling the plurality of VSPs as further described herein. Although, for the sake of clarity, a single item of instruction code 5 is shown in FIG. 3, a system according to some embodiments of the invention may include a plurality of executable code segments or modules similar to instruction code 5 that may be loaded into memory device 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Various types of input and output data may be stored in storage system 6 and may be loaded from storage system 6 into memory device 4 where it may be processed by processor or controller 2. In some embodiments, some of the components shown in FIG. 3 may be omitted. For example, memory device 4 may be a non-volatile memory having the storage capacity of storage system 6. Accordingly, although shown as a separate component, storage system 6 may be embedded or included in memory device 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output devices 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

Reference is now made to FIG. 4, which depicts system 10 for controlling a plurality of VSP, according to some embodiments.

According to some embodiments of the invention, system 10 may be implemented as a software module, a hardware module, or any combination thereof. For example, system 10 may be or may include a computing device such as element 1 of FIG. 3. Furthermore, system 10 may be adapted to execute one or more modules of instruction code (e.g., element 5 of FIG. 3) to request, receive, analyze, calculate and produce various data. As further described in detail herein, system 10 may be adapted to execute one or more modules of instruction code (e.g., element 5 of FIG. 3) in order to perform the steps of the claimed method.

As shown in FIG. 4, arrows may represent flow of one or more data elements to and from system 10 and/or among modules or elements of system 10. Some arrows have been omitted in FIG. 4 for the purpose of clarity.

In some embodiments, system 10 may be connected to closed supply network 60. Closed supply network 60 may include plurality of VSPs 70 operating to maintain the required pressure in network 60. VSPs 70 may be configured to provide information about their power statuses 71A, indicating whether a respective VSP 70 is active or inactive. VSPs 70 may be configured to provide information about a preceding set of operating speed values 70A, representing speeds at which each of VSPs 70 were previously operating (i.e., at timepoint t−1). Closed supply network 60 may include a network monitoring module 80, configured to measure preceding pressure value 80A in the network.

In some embodiments, system 10 may include flow volume demand estimation module 20.

In some embodiments, flow volume demand estimation module 20 may be configured to receive preceding pressure value 80A. Flow volume demand estimation module 20 may be further configured to receive the preceding set of operating speed values 70A of the plurality of VSPs 70. Flow volume demand estimation module 20 may be further configured to receive Q-H characteristics 10A of the plurality of the VSPs 70, each representing relation between a flow volume and a pressure at a certain operating speed of the respective VSP 70. Q-H characteristic 10A may be provided by a manufacturer of the respective VSP 70.

Flow volume demand estimation module 20 may be further configured to estimate current flow volume demand 20A of network 60, based on preceding pressure value 80A, preceding set of operating speed values 70A and Q-H characteristics 10A of the plurality of VSPs 70. Flow volume demand estimation module 20 may be further configured to estimate current flow volume demand 20A by calculating a sum of flow volumes 20A′ of the plurality of VSPs 70 for preceding pressure value 80A (as described above).

In some embodiments, system 10 may further include operating mode generating module 30.

In some embodiments, operating mode generating module 30 may be configured to receive pressure setpoint value 14A, representing a pressure value to be maintained in the network (as demonstrated in line 1 of algorithm shown in FIG. 2). Operating mode generating module 30 may be further configured to receive Q-H characteristics 10A of the plurality of VSPs 70 (as demonstrated in line 1 of algorithm shown in FIG. 2).

Operating mode generating module 30 may be further configured to receive (as demonstrated in line 1 of algorithm shown in FIG. 2) pump efficiency characteristics 11A of the plurality of VSPs 70, each representing hydraulic efficiency of respective VSP 70 as a relation between an absorbed hydraulic energy (pressure and velocity) and the provided mechanical energy at the pump crank including the power efficiency of its motor. Efficiency characteristic 11A may be provided by a manufacturer of the respective VSP 70.

Operating mode generating module 30 may be further configured to receive estimated current flow volume demand 20A (as demonstrated in line 1 of algorithm shown in FIG. 2).

Operating mode generating module 30 may be further configured to receive power status 71A for each of the plurality of VSPs 70 (as demonstrated in line 1 of algorithm shown in FIG. 2).

Operating mode generating module 30 may be further configured to calculate new set of operating speed values 30A″ of the plurality of VSPs 70, based on pressure setpoint value 14A, Q-H characteristics 10A of the plurality of VSPs 70, pump efficiency characteristics 11A of the plurality of VSPs 70, power statuses 71A of the plurality of VSPs 70, and estimated current flow volume demand 20A, such as to provide estimated current flow volume demand 20A at pressure setpoint value 14A with lowest total power consumption 40A, determined by the pump efficiency characteristics 11A (as demonstrated in lines 13-14 of algorithm shown in FIG. 2).

In particular, operating mode generating module 30 may be further configured to calculate new set of operating speed values 30A″ by calculating a plurality of feasible sets of operating speed values 30A, based on pressure setpoint value 14A, Q-H characteristics 10A, and estimated current flow volume demand 20A (as demonstrated in lines 3-11 of algorithm shown in FIG. 2). Each of feasible sets of operating speed values 30A may provide estimated current flow volume demand 20A at pressure setpoint value 14A.

In particular, operating mode generating module 30 may be further configured to calculate the plurality of the feasible sets of the operating speed values 30A by selecting at least one VSP 70 from the plurality of VSPs 70 (as demonstrated in lines 3-4 of algorithm shown in FIG. 2), and calculating each of the plurality of the feasible sets of operating speed values 30A by selecting operating speed values 30A for the rest of the plurality of VSPs 70 (as demonstrated in lines 4-6 of algorithm shown in FIG. 2), calculating a sum of flow volumes 30A′ of the rest of the plurality of VSPs 70 for pressure setpoint value 14A (as demonstrated in line 8 of algorithm shown in FIG. 2), according to selected operating speed values 30A for the rest of the plurality of VSPs 70. Operating mode generating module 30 may be further configured to calculate each of the plurality of the feasible sets of operating speed values 30A further by calculating flow volume 30A′ of selected at least one VSP 70 as a difference between estimated current flow volume demand 20A and the sum of flow volumes 30A′ of the rest of the plurality of VSPs 70 (as demonstrated in line 8 of algorithm shown in FIG. 2).

According to some embodiments, operating mode generating module 30 may be further configured to calculate each of the plurality of the feasible sets of operating speed values 30A further by calculating operating speed value 30A of selected at least one VSP 70, based on flow volume 30A′ of selected at least one VSP 70, Q-H characteristic 10A of selected at least one VSP 70, and pressure setpoint value 14A (as demonstrated in line 9 of algorithm shown in FIG. 2).

In some embodiments, operating mode generating module 30 may be further configured to receive maximum and minimum allowed operating speed values 13A for each of the plurality of VSPs 70 (as demonstrated in line 1 of algorithm shown in FIG. 2), which may be provided by the manufacturers of VSPs 70. Operating mode generating module 30 may be further configured to calculate the new set of operating speed values 30A″, by selecting each of operating speed values 30A″ within a range, defined by respective maximum and minimum allowed operating speed values 13A (as demonstrated in line 5 of algorithm shown in FIG. 2).

In particular, operating mode generating module 30 may be further configured to select operating speed values 30A for the rest of the plurality of VSPs 70 by discretizing, for each of the rest of the plurality of VSPs 70, operating speed values 30A within a range, defined by respective maximum and minimum allowed operating speed values 13A (as demonstrated in line 5 of algorithm shown in FIG. 2), thereby obtaining a plurality of discrete operating speed values 30A″′ (as demonstrated in line 6 of algorithm shown in FIG. 2). Operating mode generating module 30 may be further configured to select operating speed values 30A for the rest of the plurality of VSPs 70 from the pluralities of the discrete operating speed values 30A″′ (as demonstrated in line 7 of algorithm shown in FIG. 2).

In some embodiments, operating mode generating module 30 may be further configured to calculate the plurality of the feasible sets of operating speed values 30A further by excluding the feasible sets of the operating speed values 30A having the operating speed value 30A of selected at least one VSP 70 out of the range, defined by respective maximum and minimum allowed operating speed values 13A (as demonstrated in line 10 of algorithm shown in FIG. 2).

In some embodiments, system 10 may further include power consumption estimating module 40.

In some embodiments, power consumption estimating module 40 may be configured to receive the plurality of the feasible sets of the operating speed values 30A. Power consumption estimating module 40 may be further configured to receive pump efficiency characteristics 11A (as demonstrated in line 1 of algorithm shown in FIG. 2). Power consumption estimating module 40 may be further configured to receive flow volumes 30A′ of the plurality of VSPs 70. Power consumption estimating module 40 may be further configured to receive pressure setpoint value 14A (as demonstrated in line 1 of algorithm shown in FIG. 2).

Power consumption estimating module 40 may be further configured to calculate, for each of the plurality of feasible sets of operating speed values 30A, total power consumption 40A of the plurality of VSPs 70, derived from pump efficiency characteristics 11A of the plurality of VSPs 70 (as demonstrated in lines 11-12 of algorithm shown in FIG. 2).

In particular, power consumption module 40 may be further configured to calculate, for each of the plurality of VSPs 70, pump efficiency value 40A′, based on operating speed value 30A of respective VSP 70 according to the respective feasible set, flow volume 30A′ of respective VSP 70 for pressure setpoint value 14A, pump efficiency characteristic 11A of respective VSP 70 (as demonstrated in lines 11-12 of algorithm shown in FIG. 2). Power consumption module 40 may be further configured to calculate total power consumption 40A of the plurality of the VSPs 70, based on pressure setpoint value 14A, flow volume 30A′ of each of the plurality of VSPs 70 for pressure setpoint value 14A, calculated pump efficiency value 40A′ of each of the plurality of VSPs 70 (as demonstrated in lines 11-12 of algorithm shown in FIG. 2).

In some embodiments, system 10 may further include controlling module 50.

In some embodiments, controlling module 50 may be configured to receive the plurality of the feasible sets of operating speed values 30A. Controlling module 50 may be further configured to receive total power consumption 40A for each plurality of the feasible sets of the operating speed values 30A.

Controlling module 50 may be further configured to receive power status constraint parameter 12A, representing an upper limit of a power status change frequency (i.e., switching between “on” and “off” conditions).

Controlling module 50 may be further configured to select the new set of operating speed values 30A″ from the plurality of feasible sets of operating speed values 30A, having the lowest total power consumption 40A.

Controlling module 50 may be further configured to reconfigure the plurality of the VSPs 70 by setting up the new set of operating speed values 30A″.

In some embodiments, controlling module 50 may be further configured to reconfigure the plurality of the VSPs 70 by changing their power statuses 71A (i.e., switching respective VSPs 70 on and off). In order to do that, controlling module 50 may be further configured to select the new set of operating speed values 30A, further based on power status constraint parameter 12A (i.e., by rejecting the feasible sets of operating speed values 30A having power status change frequency above the upper limit).

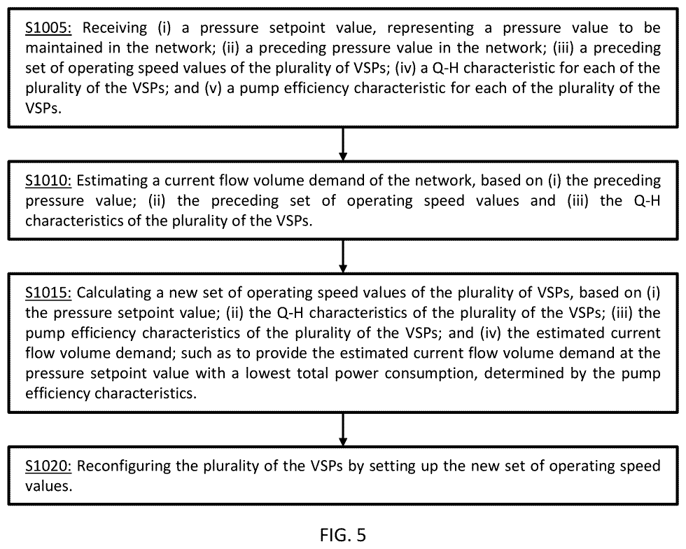

Referring now to FIG. 5, a flow diagram is presented, depicting a method of controlling a plurality of VSPs 70 connected to closed supply network 60, by at least one processor, according to some embodiments.

As shown in step S1005, the at least one processor (e.g., processor 2 of FIG. 3) may perform receiving of (i) a pressure setpoint value (e.g., pressure setpoint value 14A), representing a pressure value to be maintained in the network (e.g., network 60); (ii) a preceding pressure value (e.g., preceding pressure value 60) in the network (e.g., network 60); (iii) a preceding set of operating speed values of the plurality of VSPs (e.g., preceding set of operating speed values 70A of VSPs 70); (iv) a Q-H characteristic (e.g., Q-H characteristic 10A) for each of the plurality of the VSPs (e.g., VSPs 70); and (v) a pump efficiency characteristic (e.g., pump efficiency characteristic 11A) for each of the plurality of the VSPs (e.g., VSPs 70). Step S1005 may be carried out by flow volume demand estimation module 20, operating mode generating module 30 and power consumption estimating module 40 (as described with reference to FIG. 4).

As shown in step S1010, the at least one processor (e.g., processor 2 of FIG. 3) may perform estimating of a flow volume demand (e.g., flow volume demand 20A) of the network (e.g., network 60), based on (i) the preceding pressure value (e.g., preceding pressure value 80A); (ii) the preceding set of operating speed values (e.g., operating speed values 70A) and (iii) the Q-H characteristics (e.g., Q-H characteristics 10A) of the plurality of the VSPs (e.g., VSPs 70). Step S1010 may be carried out by flow volume demand estimation module 20 (as described with reference to FIG. 4).

As shown in step S1015, the at least one processor (e.g., processor 2 of FIG. 3) may calculate a new set of operating speed values (e.g., new set of operating speed values 30A″) of the plurality of VSPs (e.g., VSPs 70), based on (i) the pressure setpoint value (e.g., pressure setpoint value 14A); (ii) the Q-H characteristics (e.g., Q-H characteristics 10A) of the plurality of the VSPs (e.g., VSPs 70); (iii) the pump efficiency characteristics (e.g., pump efficiency characteristics 11A) of the plurality of the VSPs (e.g., VSPs 70); and (iv) the estimated current flow volume demand (e.g., flow volume demand 20A); such as to provide the estimated current flow volume demand (e.g., flow volume demand 20A) at the pressure setpoint value (e.g., pressure setpoint value 14A) with a lowest total power consumption (e.g., total power consumption 40A), determined by the pump efficiency characteristics (e.g., pump efficiency characteristics 11A). Step S1015 may be carried out by operating mode generating module 30, power consumption estimating module 40 and controlling module 50 (as described with reference to FIGS. 2 and 4).

As shown in step S1020, the at least one processor (e.g., processor 2 of FIG. 3) may be configured to reconfigure the plurality of the VSPs (e.g., VSPs 70) by setting up the new set of operating speed values (e.g., new set of operating speed values 30A″). Step S1020 may be carried out by controlling module 50 (as described with reference to FIG. 4).

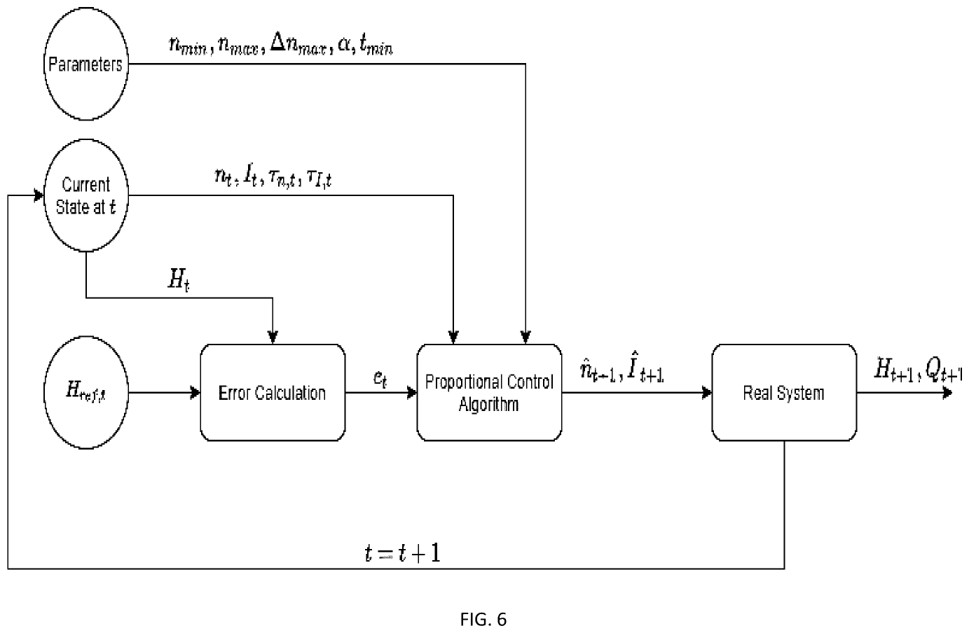

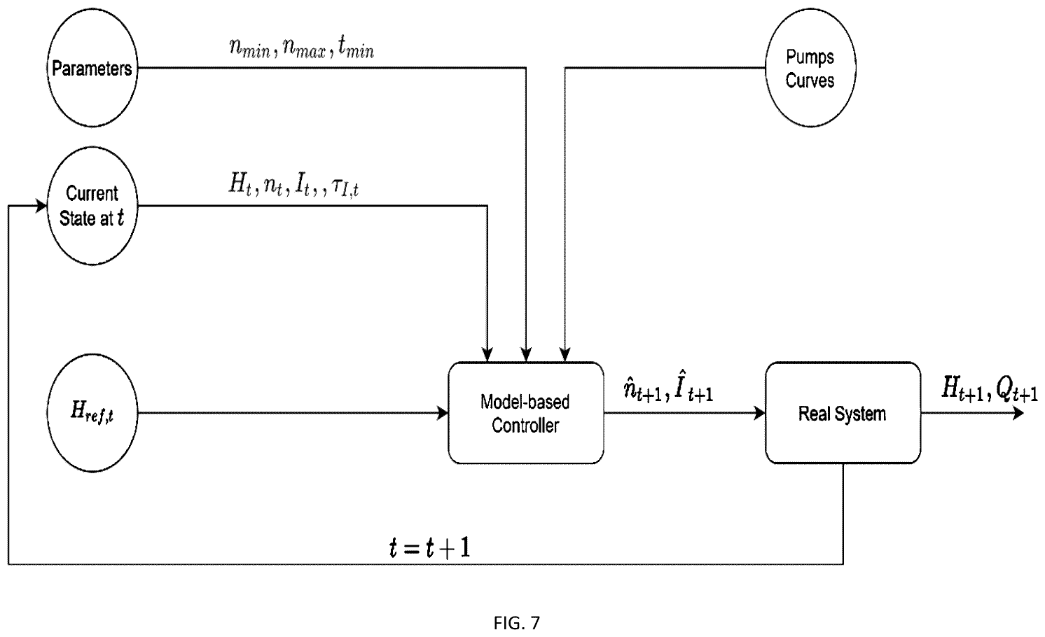

Reference now is made to FIGS. 6 and 7, depicting the common VSP control loop, known from the art (FIG. 6) and proposed control loop according to some embodiments of the present invention (FIG. 7).

For each time step t, the current state of the system is obtained from the SCADA, which includes the on\off state of the pumps, I, their speed, n, and the last update time of these values, τ_{I} and τₙ respectively. The reference pressure (pressure setpoint value), H_{ref}, and the measured pressure (preceding pressure value), H are also obtained. The difference (error) between these values is calculated, e, and fed to the proportional control algorithm (PCA). Some parameters for the PCA are predetermined: the minimum and maximum allowed speeds of the pumps, nₘᵢₙ and nₘₐₓ respectively, the maximum allowed changed in the pump's speed, Δnₘₐₓ, the proportional coefficient, α, which is the change in the pump's speed relative to the calculated error (e). A minimum time, tₘᵢₙ, is also set to limit the time between major changes in pumps operations (e.g., start, stop, reduce the pump's speed from nₘₐₓ). The output of the PCA are the adjusted values for I and n, denoted as Î and \hat{n} respectively. When these new settings are applied to the system, the system will respond with new values of the pressure and the flow, Hₜ₊₁ and Qₜ₊₁ respectively. At this stage, the control loop is repeated for the next time step.

The claimed invention was tested in a real WDS, and its effectiveness was approved, as described in detail below.

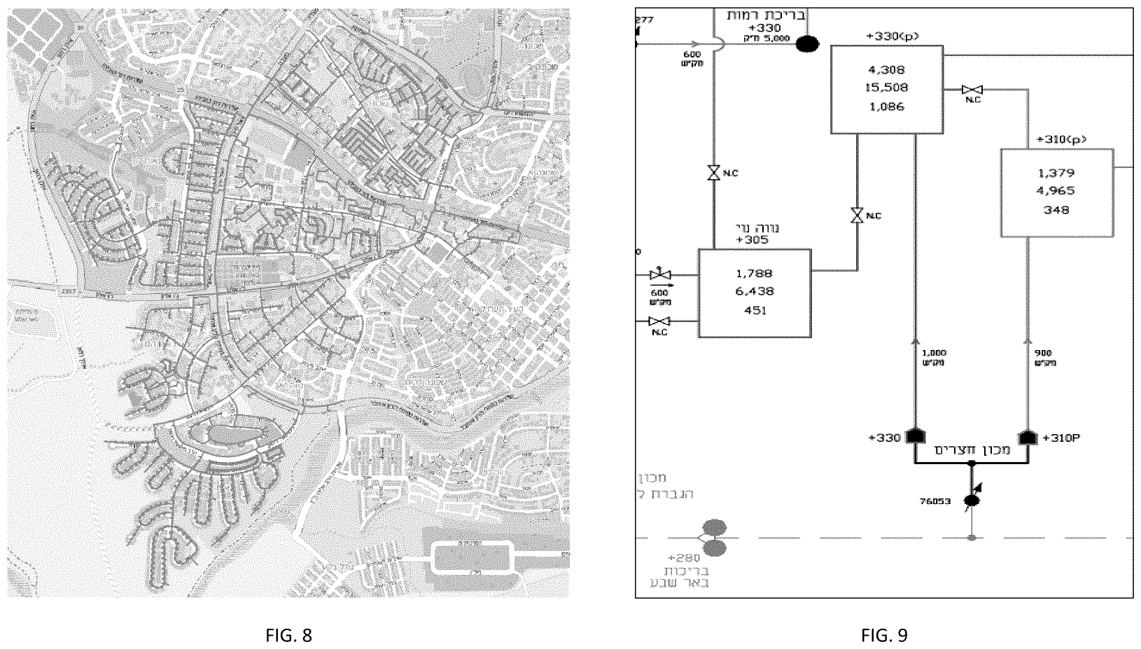

For test case, the pressure zone 330P in Mey-Sheva was taken. The WDS layout and the schematic representation of this zone are shown in FIGS. 8 and 9, respectively.

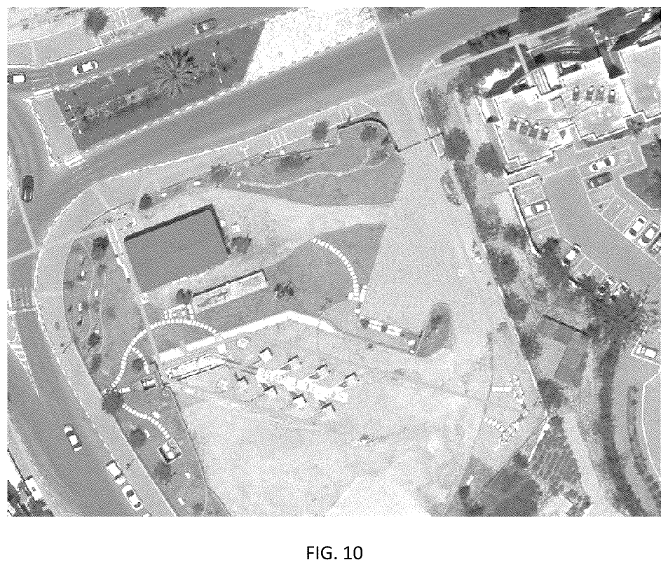

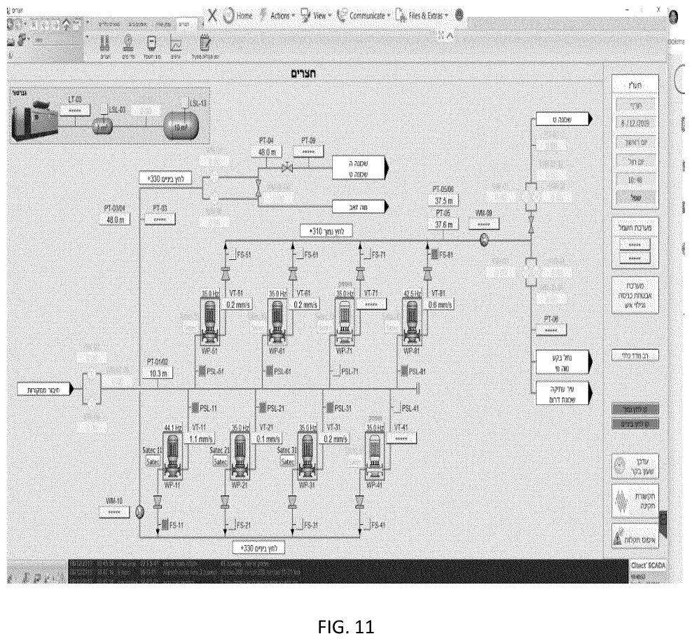

Zone 330P is supplied by a single pumping station (shown in FIG. 10) without storage tanks. The station's SCADA screen is shown in FIG. 11.

The selected pumping station has eight pumps, of which four supply water to zone 330P: pumps 1-4 (labeled WP-11, WP-21, WP-31, and WP-41). The four pumps are variable speed pumps, each operating at a different frequency. SCADA measurements are available at 30-second intervals for the suction and discharge pressures, total flow through the station, and individual pumps frequencies. These frequencies are recorded in percentage [0, 100] for the range of 35-50 Hz. When the value is 0%, it means that the pump may be working at the minimum frequency, or it is turned off. For the test, the latter is considered. There is no individual pump flow data and no power data provided, not even for the entire station.

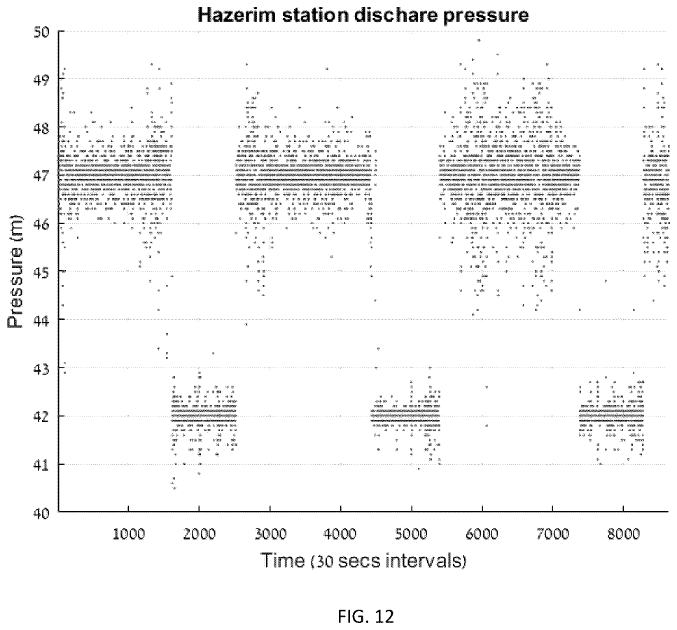

Currently, the pumps are operated to maintain the discharge pressure (according to the pressure setpoint) of the station in the following way. As demand in the zone increases, this pressure decreases, and the speed of the operating pump is increased to meet the required pressure. First, the speed is raised to the maximum speed, and then another pump is added at its lowest speed, which can be increased if the pressure continues to drop. The controlled pressure is set to ˜47 m during day hours (06:30-23:00) and to ˜42 m during night hours (23:00-0:630), as shown in FIG. 12. The pump curve parameters are shown in Error! Reference source not found. below.

TABLE 1
Pump curve parameters

| Pump | a | b (×10⁻⁴) |
|---|---|---|
| 1 | 66.29 | 0.701 |
| 2 | 65.78 | 5.826 |
| 3 | 83.93 | 1.309 |
| 4 | 51.07 | 1.073 |

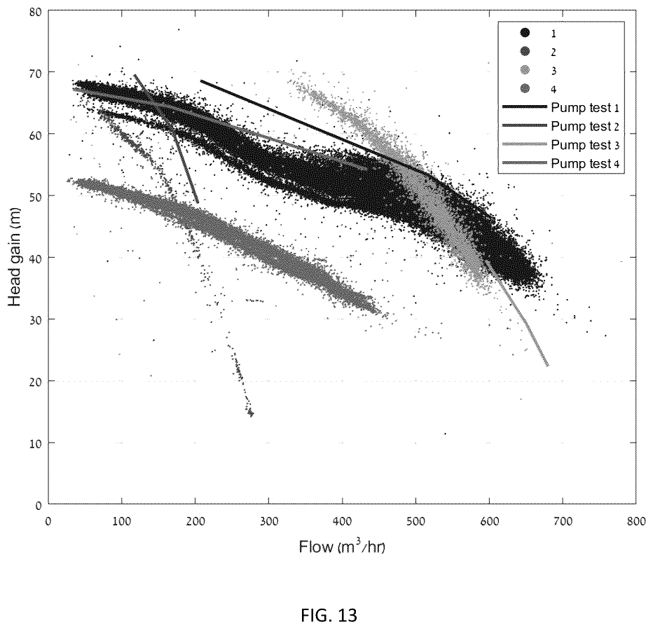

These parameters are derived by analyzing the SCADA data of the pump performance, as shown in FIG. 13, using the methodology known in the art.

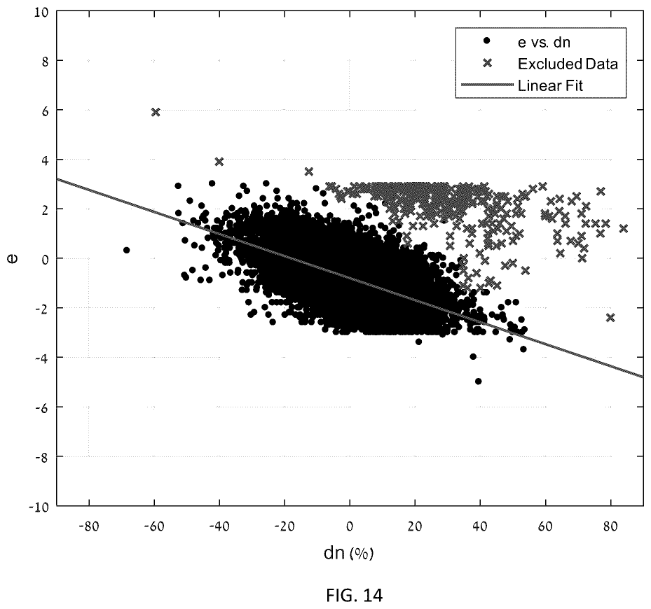

As a first step, the available SCADA data of the station was used to “reverse-engineer” the proportional controller parameters. Given the records of the pumps' speed and the measured head (pressure in the network), the control logic was derived that dictates the changes in the speed as a function of the deviation between the measured and the reference head (preceding pressure value and pressure setpoint value). FIG. 14 shows the linear fit between the error of the change in the speed of the first pump. The slope of the linear line of −0.05 indicates that a deviation of one meter above the reference pressure reduces the pump speed by 5%, while a deviation of one meter below the reference increases the pump speed by 5%. The linear fit is derived using the LAR regression technique while excluding outliers, as shown in FIG. 14.

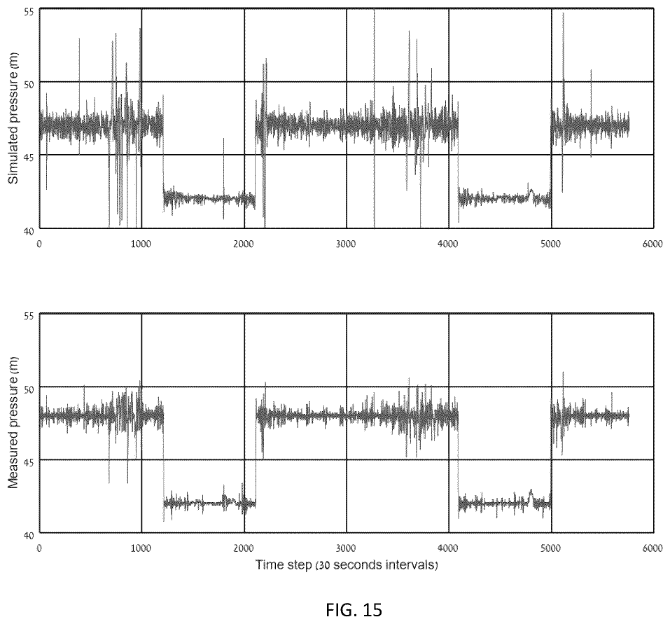

Using the above reverse engineered parameter and utilizing the proportional control algorithms presented previously, the operation of the Hazerim pumping station was simulated. Initial results are shown in FIG. 15, in which the simulated pressure is shown in the top figure while the measured pressure is on the bottom. The similarity between the measured and simulated pressure can be easily observed.

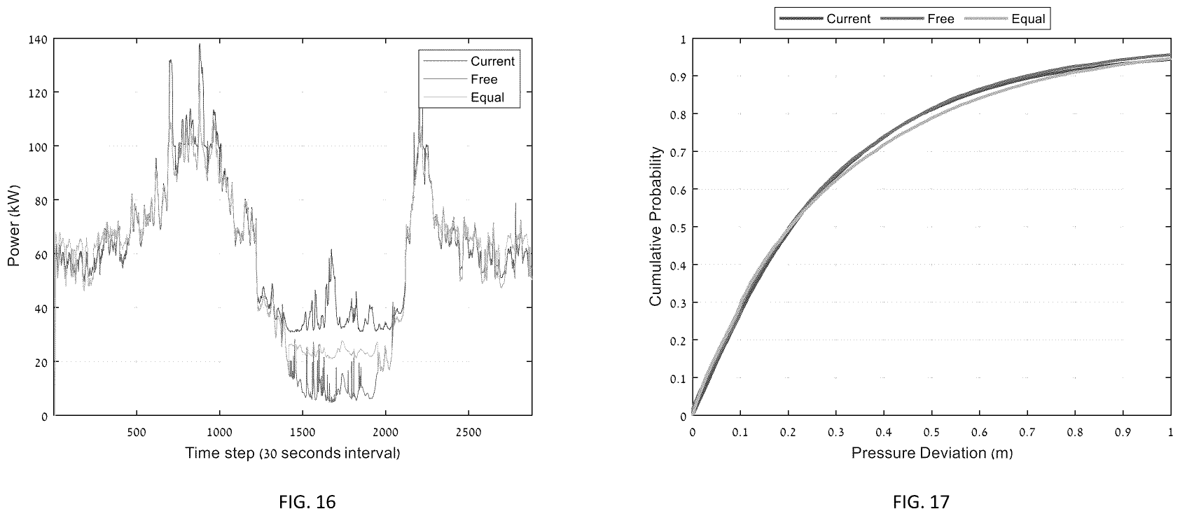

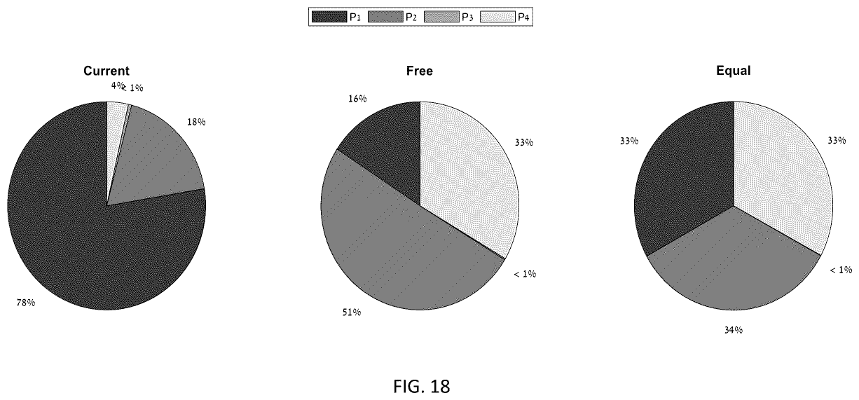

The optimization results for two days (out of a representative week) are shown in FIG. 16. The results show that the free strategy outperforms the business as usual strategy and the equal speed strategy since it reduced the power consumption in specific periods. This good performance is still achieved while meeting the target pressure, as demonstrated in FIG. 17. The figure shows the cumulative probability density function of the three strategies' absolute pressure deviation from the set pressure. The overlapping of the curves indicates that all strategies sustain the required pressure.

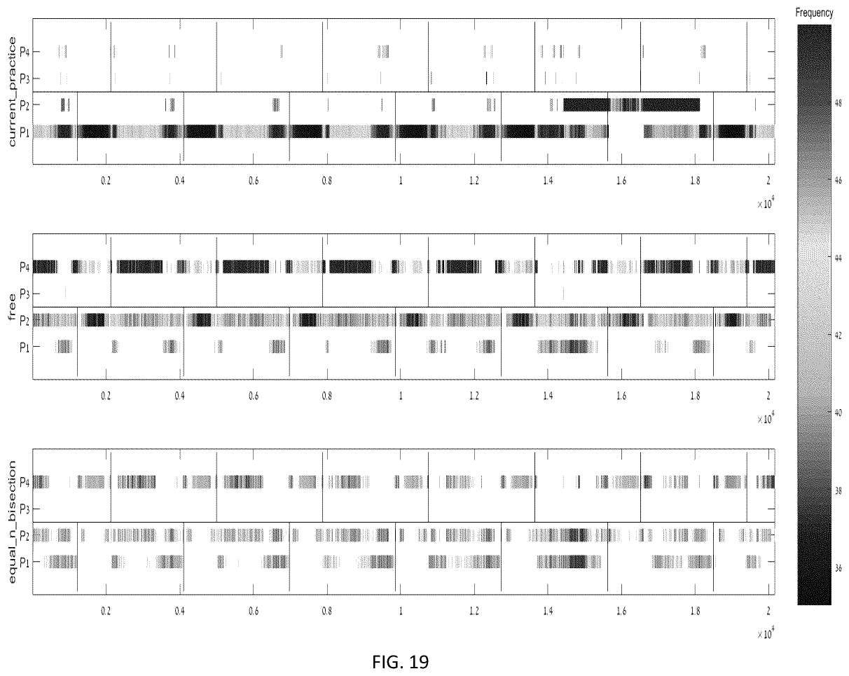

FIG. 19 shows that both optimization strategies (free and equal) achieve better balanced operation. Namely, they allocate balanced operation hours for the pumps. FIG. 19 shows the optimal schedule of the pumps during the first two days of the week.

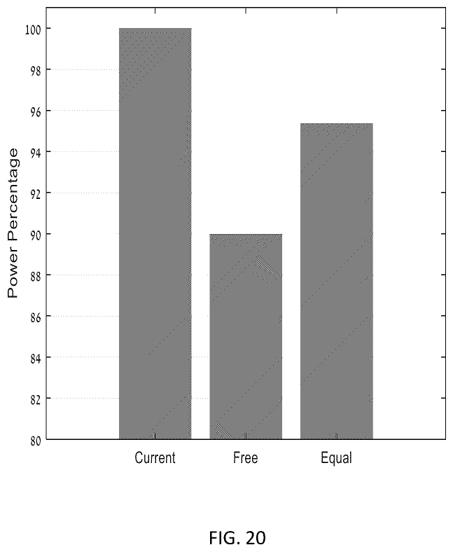

Finally, the overall savings of the optimization approaches compared to the current practice are shown in FIG. 20. Again, the results show that the energy-saving is as high as 10%.

As described, embodiments of the invention may include a practical application for method and system for controlling a plurality of VSPs in different fields of endeavor. Embodiments of the claimed invention may thus provide an improvement in the technological field of automated process control systems and methods.

Consequently, as can be seen from the provided disclosure, the claimed invention represents a system and method of controlling a plurality of VSPs, which provide a technical improvement of a technical field of automated process control by decreasing the total and instantaneous power consumption of the plurality of VSPs while maintaining the required flow volume demand at the desired pressure setpoint, as well as increasing the effectiveness of adjustment to changing demands of the network and extending motor life of pumps by balancing frequency of their starts and stops.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of controlling a plurality of variable speed pumps (VSPs) connected to a closed supply network, by at least one processor, the method comprising:
receiving (i) a pressure setpoint value, representing a pressure value to be maintained in the network; (ii) a preceding pressure value in the network; (iii) a preceding set of operating speed values of the plurality of VSPs; (iv) a Q-H characteristic for each of the plurality of the VSPs; and (v) a pump efficiency characteristic for each of the plurality of the VSPs;
estimating a current flow volume demand of the network, based on (i) the preceding pressure value; (ii) the preceding set of operating speed values and (iii) the Q-H characteristics of the plurality of the VSPs;
calculating a new set of operating speed values of the plurality of VSPs, based on (i) the pressure setpoint value; (ii) the Q-H characteristics of the plurality of the VSPs; (iii) the pump efficiency characteristics of the plurality of the VSPs; and (iv) the estimated current flow volume demand; such as to provide the estimated current flow volume demand at the pressure setpoint value with a lowest total power consumption, determined by the pump efficiency characteristics; and
reconfiguring the plurality of the VSPs by setting up the new set of operating speed values.

2. The method of claim 1, further comprising
receiving a power status for each of the plurality of the VSPs, indicating whether a respective VSP is active or inactive; and
calculating the new set of operating speed values, further based on the power statuses of the plurality of the VSPs.

3. The method, further comprising
receiving a power status constraint parameter, representing an upper limit of a power status change frequency; and
calculating the new set of operating speed values, further based on the power status constraint parameter.

4. The method of claim 1, further comprising
receiving maximum and minimum allowed operating speed values for each of the plurality of the VSPs; and
calculating the new set of operating speed values, by selecting each of operating speed values within a range, defined by a respective maximum and minimum allowed operating speed values.

5. The method of claim 1, wherein estimating the current flow volume demand comprises calculating a sum of flow volumes of the plurality of the VSPs for the preceding pressure value.

6. The method of claim 1, wherein calculating the new set of operating speed values of the plurality of VSPs comprises
calculating a plurality of feasible sets of operating speed values, based on (i) the pressure setpoint value; (ii) the Q-H characteristics of the plurality of the VSPs; and (iii) the estimated current flow volume demand; each providing the estimated current flow volume demand at the pressure setpoint value;
for each of the plurality of feasible sets of operating speed values, calculating a total power consumption of the plurality of the VSPs, derived from the pump efficiency characteristics of the plurality of the VSPs;
selecting the new set of operating speed values from the plurality of feasible sets of operating speed values, having the lowest total power consumption of the plurality of the VSPs.

7. The method of claim 6, wherein calculating the plurality of the feasible sets of the operating speed values comprises
selecting at least one VSP from the plurality of the VSPs; and
calculating each of the plurality of the feasible sets of the operating speed values by:
selecting the operating speed values for the rest of the plurality of the VSPs;
calculating a sum of the flow volumes of the rest of the plurality of the VSPs for the pressure setpoint value, according to the selected operating speed values for the rest of the plurality of the VSPs;
calculating the flow volume of the selected at least one VSP as a difference between the estimated current flow volume demand and the sum of the flow volumes of the rest of the plurality of the VSPs;
calculating the operating speed value of the selected at least one VSP, based on (i) the flow volume of the selected at least one VSP; (ii) the Q-H characteristic of the selected at least one VSP; and (iii) the pressure setpoint value.

8. The method of claim 7, wherein calculating the total power consumption of the plurality of the VSPs further comprises
for each of the plurality of the VSPs, calculating a pump efficiency value, based on (i) the operating speed value of the respective VSP according to the respective feasible set; (ii) flow volume of the respective VSP for the pressure setpoint value; (iii) the pump efficiency characteristic of the respective VSP; and
calculating the total power consumption of the plurality of the VSPs, based on (i) the pressure setpoint value; (ii) the flow volume of each of the plurality of the VSPs for the pressure setpoint value; (iv) the calculated pump efficiency value of each of the plurality of the VSPs.

9. The method of claim 7, further comprising
receiving maximum and minimum allowed operating speed values for each of the plurality of the VSPs; and
wherein selecting the operating speed values for the rest of the plurality of the VSPs comprises,
for each of the rest of the plurality of the VSPs, discretizing the operating speed values within a range, defined by a respective maximum and minimum allowed operating speed values, thereby obtaining a plurality of discrete operating speed values; and
selecting the operating speed values for the rest of the plurality of the VSPs from the pluralities of the discrete operating speed values.

10. The method of claim 9, wherein calculating the plurality of the feasible sets of the operating speed values further comprises excluding the feasible sets of the operating speed values having the operating speed value of the selected at least one VSP out of the range, defined by a respective maximum and minimum allowed operating speed values.

11. A system for controlling a plurality of variable speed pumps (VSPs) connected to a closed supply network, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive (i) a pressure setpoint value, representing a pressure value to be maintained in the network; (ii) a preceding pressure value in the network; (iii) a preceding set of operating speed values of the plurality of VSPs; (iv) a Q-H characteristic for each of the plurality of the VSPs; and (v) a pump efficiency characteristic for each of the plurality of the VSPs;
estimate a current flow volume demand of the network, based on (i) the preceding pressure value; (ii) the preceding set of operating speed values and (iii) the Q-H characteristics of the plurality of the VSPs;
calculate a new set of operating speed values of the plurality of VSPs, based on (i) the pressure setpoint value; (ii) the Q-H characteristics of the plurality of the VSPs; (iii) the pump efficiency characteristics of the plurality of the VSPs; and (iv) the estimated current flow volume demand; such as to provide the estimated current flow volume demand at the pressure setpoint value with a lowest total power consumption, determined by the pump efficiency characteristics; and
reconfigure the plurality of the VSPs by setting up the new set of operating speed values.

12. The system of claim 11, wherein the at least one processor is further configured to receive a power status for each of the plurality of the VSPs, indicating whether a respective VSP is active or inactive; and
calculate the new set of operating speed values, further based on the power statuses of the plurality of the VSPs.

13. The system of claim 11, wherein the at least one processor is further configured to:
receive a power status constraint parameter, representing an upper limit of a power status change frequency; and
calculate the new set of operating speed values, further based on the power status constraint parameter.

14. The system of claim 11, wherein the at least one processor is further configured to:
receive maximum and minimum allowed operating speed values for each of the plurality of the VSPs; and
calculate the new set of operating speed values, by selecting each of operating speed values within a range, defined by a respective maximum and minimum allowed operating speed values.

15. The system of claim 11, wherein the at least one processor is further configured to estimate the current flow volume demand by calculating a sum of flow volumes of the plurality of the VSPs for the preceding pressure value.

16. The system of claim 11, wherein the at least one processor is further configured to calculate the new set of operating speed values of the plurality of VSPs by calculating a plurality of feasible sets of operating speed values, based on (i) the pressure setpoint value; (ii) the Q-H characteristics of the plurality of the VSPs; and (iii) the estimated current flow volume demand; each providing the estimated current flow volume demand at the pressure setpoint value;
for each of the plurality of feasible sets of operating speed values, calculating a total power consumption of the plurality of the VSPs, derived from the pump efficiency characteristics of the plurality of the VSPs; and
selecting the new set of operating speed values from the plurality of feasible sets of operating speed values, having the lowest total power consumption of the plurality of the VSPs.

17. The system of claim 16, wherein the at least one processor is further configured to calculate the plurality of the feasible sets of the operating speed values by:
selecting at least one VSP from the plurality of the VSPs; and
calculating each of the plurality of the feasible sets of the operating speed values by:
selecting the operating speed values for the rest of the plurality of the VSPs;
calculating a sum of the flow volumes of the rest of the plurality of the VSPs for the pressure setpoint value, according to the selected operating speed values for the rest of the plurality of the VSPs;
calculating the flow volume of the selected at least one VSP as a difference between the estimated current flow volume demand and the sum of the flow volumes of the rest of the plurality of the VSPs;
calculating the operating speed value of the selected at least one VSP, based on (i) the flow volume of the selected at least one VSP; (ii) the Q-H characteristic of the selected at least one VSP; and (iii) the pressure setpoint value.

18. The system of claim 17, wherein the at least one processor is further configured to calculate the total power consumption of the plurality of the VSPs further by:
for each of the plurality of the VSPs, calculating a pump efficiency value, based on (i) the operating speed value of the respective VSP according to the respective feasible set; (ii) flow volume of the respective VSP for the pressure setpoint value; (iii) the pump efficiency characteristic of the respective VSP; and
calculating the total power consumption of the plurality of the VSPs, based on (i) the pressure setpoint value; (ii) the flow volume of each of the plurality of the VSPs for the pressure setpoint value; (iv) the calculated pump efficiency value of each of the plurality of the VSPs.

19. The system of claim 17, wherein the at least one processor is further configured to receive maximum and minimum allowed operating speed values for each of the plurality of the VSPs; and
select the operating speed values for the rest of the plurality of the VSPs by:
for each of the rest of the plurality of the VSPs, discretizing the operating speed values within a range, defined by a respective maximum and minimum allowed operating speed values, thereby obtaining a plurality of discrete operating speed values; and
selecting the operating speed values for the rest of the plurality of the VSPs from the pluralities of the discrete operating speed values.

20. The system of claim 19, wherein the at least one processor is further configured to calculate the plurality of the feasible sets of the operating speed values further by excluding the feasible sets of the operating speed values having the operating speed value of the selected at least one VSP out of the range, defined by a respective maximum and minimum allowed operating speed values.
